(19) United States
(12) Patent Application Publication
(10) Pub. No.: US 2015/0285714 A1
(43) Pub. Date: Oct. 8, 2015

(54) INTEGRAL SAMPLE IDENTIFICATION THROUGHOUT A WORKFLOW PROCESS

(71) Applicant: Waters Technologies Corporation, Milford, MA (US)

(72) Inventors: Pamela J. Longenbach, Northborough, MA (US); Moon Chul Jung, Arlington, MA (US); Frank John Marszalkowski, JR., Cumberland, RI (US); Geoff Gerhardt, Woonsocket, RI (US)

(21) Appl. No.: 14/679,605

(22) Filed: Apr. 6, 2015

Related U.S. Application Data
(60) Provisional application No. 62/039,602, filed on Aug. 20, 2014.
(60) Provisional application No. 61/976,738, filed on Apr. 8, 2014.

(51) Int. Cl. G01N 1/10; B01L 3/00

(52) U.S. Cl. CPC G01N 1/10; B01L 3/5082; B01L 2200/10; B01L 2300/044; B01L 2300/0681; B01L 2300/0832

(57) ABSTRACT

Provided are devices and methods for sample collection and processing. A tubular body has a chamber closed at a first end by a thin penetrable barrier and open at a second end opposite the first end. The tubular body further includes a partition that divides the chamber into two adjacent compartments, wherein a first compartment of the two adjacent compartments has the partition facing opposite the open end of the chamber and a second compartment of the two adjacent compartments has the partition facing opposite the closed end of the chamber. The partition has one or more holes to allow passage of fluid from the first compartment into the second compartment. A tracking identification may be permanently affixed to the first end of the tubular body.

### RELATED APPLICATIONS

This application is related to Patent Cooperation Treaty (PCT) application PCT/US13/61512, filed Sep. 25, 2013, titled “Apparatus and Method for Analyte Extraction,” and claims priority to and the benefit of U.S. provisional application No. 62/039,602, filed Aug. 20, 2014, titled “Integral Sample Identification throughout a Workflow Process,” and U.S. provisional application No. 61/976,738, filed Apr. 8, 2014, titled “Integral Sample Identification throughout a Workflow Process,” the entireties of which aforementioned applications are incorporated by reference herein.

### FIELD OF THE INVENTION

The present inventive concepts relate generally to techniques related to sample analyses. More particularly, the present inventive concepts relate to systems and methods for tracking a sample from collection to processing.

### BACKGROUND

A sample to be analyzed typically enters a laboratory in a vial or other container having an identification, for example, a label, that uniquely identifies the sample. During a sample workflow process, the sample can be dissolved, extracted, transferred, filtered, and/or analyzed. During the process, the sample is transferred between the container having the identification and one or more other containers. In doing so, the sample is separated from its original identification located on the container.

### SUMMARY

All examples and features mentioned below can be combined in any technically possible way.

In one aspect, a sample collection and processing device comprises a tubular body having a chamber closed at a first end by a thin penetrable barrier and open at a second end opposite the first end. The tubular body further includes a partition that divides the chamber into two adjacent compartments, wherein a first compartment of the two adjacent compartments has the partition facing opposite the open end of the chamber and a second compartment of the two adjacent compartments has the partition facing opposite the closed end of the chamber. The partition has one or more holes to allow passage of fluid from the first compartment into the second compartment.

Embodiments of the sample collection and processing device may include one of the following features, or any combination thereof.

The device may further comprise an absorbent medium, used to collect a sample, disposed in the first compartment adjacent to the partition. A filtration medium, used to filter liquid, may also be disposed in the first compartment between the absorbent medium and the partition. A cleanup medium, used to remove constituents from liquid, may also be disposed in the first compartment between the absorbent medium and the filter medium.

In one embodiment, the absorbent medium may be a portion of a dried biological sample spot card. Some embodiments include a filtration medium, used to filter liquid, disposed in the first compartment adjacent to the partition or a cleanup medium, used to remove constituents from liquid, disposed in the first compartment adjacent to the partition.

In one embodiment, the partition comprises an absorbent medium used to collect a sample. The absorbent medium may be a portion of a dried biological sample spot card.

The device may further comprise a cutter extending from an edge of the tubular body at the open end of the chamber. The device may further comprise a tracking identification permanently affixed to a face of the thin penetrable barrier that closes the first end of the chamber, or permanently affixed to an external surface around the tubular body at the closed end of the chamber. The thin penetrable barrier may comprise a septum. The tubular body may tapered at the open end of the chamber.

The device may further comprise a container for holding a liquid, wherein the container has an open end sized for closely receiving the open end of tubular body.

In another aspect, a method for sample collection and processing for use in a laboratory workflow process comprises collecting a sample into a first compartment of a tubular body of a sample-collection and processing device through an open end of the tubular body. Liquid is added to the sample in the first compartment of the tubular body to process the sample. Liquid is transferred from the first compartment of the tubular body into a second compartment of the tubular body through one or more holes in a partition disposed between the compartments. A portion of the liquid with the processed sample is withdrawn from the second compartment through a penetrable thin barrier forming a closed end of the tubular body opposite the open end.

Embodiments of the method may include one of the following features, or any combination thereof.

The collecting of a sample into a first compartment of a tubular body through an open end of the tubular body may include collecting the sample with an absorbent medium disposed in the first compartment adjacent to the partition or include cutting an absorbent medium from a dried biological sample spot card with the sample and inserting the absorbent medium with the sample into the first compartment of the tubular body.

The partition may comprise an absorbent medium. The thin penetrable barrier may comprise a septum.

The method may further comprise permanently affixing tracking identification to a surface at the closed end of the tubular body. The sample collection and processing device may be transported from a first station in the laboratory workflow process, where the sample is collected into the first compartment, to one or more intermediate stations where liquid is added to the first compartment and is transferred to the second compartment, and then to a final station in the laboratory workflow process, where the portion of the liquid with the processed sample is withdrawn from the second compartment for analysis.

Adding liquid to the sample in the first compartment of the tubular body may include inserting the open end of the tubular body into a container holding the liquid. The inserting of the open end of the tubular body into the container holding the liquid may force the liquid with the processed sample from the first compartment of the tubular body into the second compartment of the tubular body through the one or more holes in the partition disposed between the compartments. Adding liquid to the sample in the first compartment of the tubular body may operate to process the sample by at least one of extraction, dissolution, and dilution.

In another aspect, a method for sample collection and processing for use in a chromatography workflow process comprises collecting a sample at an absorbent permeable medium at one end of a container body for transfer to a reservoir between the one end and another end of the container body at which a tracking identification is permanently affixed, and removing, from the other end of the container body having the permanently affixed tracking identification, the sample at the reservoir.

Embodiments of the method may include one of the following features, or any combination thereof.

The method may include removing, from the other end of the container body having the permanently affixed tracking identification, the sample at the reservoir, or removing the sample from the reservoir via a septum affixed to an opening to the reservoir at the other end of the container body.

The other end of the container body at which the tracking identification is affixed may be formed of a same mold or machined from a common stock as the rest of the container body. The other end of the container body may be formed separately from the container body and coupled to the body.

Collecting the sample may comprise cutting, by a cutter at the one of the container body, a selected region having the sample at the absorbent permeable medium, and positioning the selected region having the sample at the absorbent media at the one end of the container body.

In still another aspect, a sample collection and processing device for use in a chromatography system comprises a container body that holds a sample from a time of collection of the sample in a workflow process to a time of removal of the sample for analysis in the workflow process, and a reservoir in the container body; and an absorbent permeable medium at a first end of the container body at which the sample is received at the time of collection. The first end includes one or more openings through which the sample is input from the absorbent permeable medium to the reservoir. The device further comprises a septum covering a second end of the container body opposite the first end. The septum is penetrable by a device for withdrawing the sample from the reservoir. The device further comprises a tracking identification permanently affixed to an exterior surface at the second end of the container body such that the tracking identification remains with the container body during the workflow process from the time of collection of the sample to the time of removal of the sample for analysis.

Embodiments of the device may include one of the following features, or any combination thereof.

The exterior surface may include a surface of the septum, and wherein the tracking identification is hardcoded or preprinted on the surface of the septum. The exterior surface may include a surface of the container body about the septum, and wherein the tracking identification is attached to the surface of the container body about the septum.

The second end of the container body at which the tracking identification is permanently affixed may be formed of a same mold or machined from a common stock as the rest of the container body. The second end of the container body may be formed separately from the container body and coupled to the body.

The device may further comprise a cutter extending from the first end of the container body, the cutter configured to cut about a selected region having the sample. The container body may be configured as a filter vial.

In yet another aspect, a collection and processing device comprises an elongated support device, a sample holding element at a first end of the support device that holds a sample from a time of collection of the sample in a workflow process to a time of removal of the sample for analysis in the workflow process, and a tracking identification permanently affixed to an exterior surface at a second end of the support device opposite the first end such that the tracking identification remains with the support device during the workflow process from the time of collection of the sample to the time of removal of the sample for analysis.

Embodiments of the device may include one of the following features, or any combination thereof.

The sample holding element may include a support ring that receives and holds the sample, or a honey-dipper member that receives and holds the sample.

The support device may be a substantially rigid rod-shaped device that extends between the sample holding element and the tracking identification, or a substantially flexible element that extends between the sample holding element and the tracking identification.

The sample holding element may be configured for insertion into a container holding a liquid that interacts with the sample.

In yet another aspect, a method for sample collection and processing for use in a laboratory workflow process comprises collecting a sample at an absorbent permeable medium at one end of a container body for transfer to a reservoir between the one end and another end of the container body at which a tracking identification is permanently affixed. The method further comprises mixing the sample with a liquid in the reservoir of the container body that interacts with the sample to produce a sample mixture, and removing, from the other end of the container body having the permanently affixed tracking identification, at least a portion of the sample mixture from the reservoir.

Embodiments of the method may include one of the following features, or any combination thereof.

Removing, at the other end of the container body having the permanently affixed tracking identification, the at least a portion of the sample mixture from the reservoir, may comprise removing the sample mixture from the reservoir through a septum permanently affixed to an opening to the reservoir at the other end of the container body.

The other end of the container body at which the tracking identification is permanently affixed may be formed of a same mold or machined from a common stock as a remainder of the container body. The other end of the container body may be formed separately from the container body and coupled to the body.

In another aspect, provided is a method for sample collection and processing for use in a laboratory workflow process. The method comprises collecting, during a sample-collection stage of the laboratory workflow process, a sample at a first end of a support device, the support device having a tracking identification permanently affixed to a second end of the support device; and removing, during a sample processing stage of the laboratory workflow process, from the first end of the support device at least a portion of the sample.

Embodiments of the method may include one of the following features, or any combination thereof.

The first end of the support device may include a support ring that receives and holds the sample, or a honey-dipper member that receives and holds the sample.

Removing from the first end of the support device at least a portion of the sample may comprise positioning the first end of the support device in a container holding a liquid that interacts with the sample to produce a mixture in the container.

In accordance with another aspect, a collection and processing device for use in a laboratory workflow process comprises a container body that holds a sample from a time of collection of the sample in the laboratory workflow process to a time of removal of at least a portion of the sample for analysis in the laboratory workflow process. The collection and processing device further comprises a reservoir in the container body and an absorbent permeable medium at a first end of the container body at which the sample is received at the time of collection. The first end includes one or more openings through which the sample is introduced into the reservoir from the absorbent permeable medium. The collection and processing device further comprises a tracking identification permanently affixed to an exterior surface at a second end of the container body such that the tracking identification remains with the container body during the workflow process from the time of collection of the sample to the time of removal of the at least a portion of the sample for analysis.

The collection and processing device may further comprise a septum covering the second end of the container body opposite the first end, the septum being penetrable by a device for withdrawing the sample mixture from the reservoir. In some embodiments, the exterior surface may include a surface of the septum, and wherein the tracking identification is hardcoded or preprinted on the surface of the septum. In some embodiments, the exterior surface may include a surface of the container body about the septum, and the tracking identification is attached to the surface of the container body about the septum.

Embodiments of the collection and processing device may include one of the following features, or any combination thereof.

In some embodiments, the second end of the container body at which the tracking identification is permanently affixed may be formed of a same mold or machined from a common stock as the rest of the container body, or formed separately from the container body and coupled to the body. The container body may be configured as a filter vial.

In accordance with another aspect, provided is a collection and processing device. The device comprises an elongated support device; a sample holding element at a first end of the support device that holds a sample from a time of collection of the sample in a workflow process to a time of removal of at least a portion of the sample for analysis in the workflow process; and a tracking identification permanently affixed to an exterior surface at a second end of the support device opposite the first end such that the tracking identification remains with the support device during the workflow process from the time of collection of the sample to the time of removal of the sample for analysis.

Embodiments of the collection and processing device may include one of the following features, or any combination thereof.

The sample holding element may include a support ring that receives and holds the sample, or a honey-dipper member that receives and holds the sample. The support device may be a substantially rigid rod-shaped device that extends between the sample holding element and the tracking identification, or a substantially flexible element that extends between the sample holding element and the tracking identification.

### BRIEF DESCRIPTION OF THE DRAWINGS

The above and further features and advantages may be better understood by referring to the following description in conjunction with the accompanying drawings, in which like numerals indicate like structural elements and features in various figures. The drawings are not necessarily to scale, emphasis instead being placed upon illustrating the principles of features and implementations.

FIG. 1 is a diagram illustrating a conventional dried blood spot (DBS) workflow process.

FIG. 2A is a cross-sectional view of an embodiment of a collection and processing device.

FIG. 2B is a top view of the collection and processing device of FIG. 2A.

FIG. 2C is a detailed view of the collection and processing device of FIGS. 2A and 2B.

FIG. 2D is a detailed view of the collection and processing device of FIGS. 2A and 2B.

FIG. 3 is a cross-sectional view of an embodiment of a collection and processing device.

FIG. 4A is a view of an embodiment of a collection and processing device.

FIG. 4B is a view of an embodiment of a collection and processing device.

FIG. 5 is a perspective view of an embodiment of a planar collection and processing device.

FIG. 6 is a flowchart illustrating an embodiment of a method for tracking a sample.

FIG. 7 is a view of an embodiment of a collection and processing device in communication with a well plate.

FIG. 8 is a flowchart illustrating an embodiment of a method for sample collection and processing for use in a laboratory workflow process.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching is described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications, and equivalents, as will be appreciated by those of skill in the art. Those of ordinary skill having access to the teaching herein will recognize additional implementations, modifications and embodiments, as well as other fields of use, which are within the scope of the present disclosure as described herein.

During a sample workflow process, it is imperative that the identity of the sample be maintained and tracked during a workflow process, in particular, from the time that the sample is collected through the various steps in the process. Example workflow steps can include but not be limited to spotting the sample onto a collection card, transferring the spotted sample to an extraction tube, and/or transferring an aliquot of the resulting sample extract to a vial or other container for subsequent analysis or other processing.

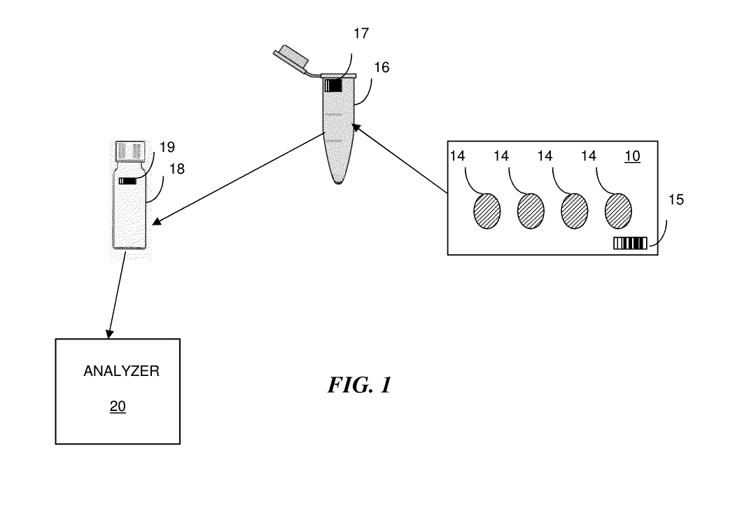

FIG. 1 shows a conventional dried blood spot (DBS) workflow process. One or more blood spot samples 14 can be provided on a collection card 10 formed of an absorbent media.

The blood can be air dried on the collection card 10. Subsequently, some or all of one or more blood spot samples 14 can be punched or otherwise detached from the collection card 10, and transferred to an extraction tube 16 such as a micro-centrifuge tube or the like. The DBS sample 14 removed from the collection card 10 can be mixed with a solvent to extract the DBS components, including at least one analyte of interest from the dried sample. Here, the DBS sample 14 can be mixed with an extraction solvent such as methanol and optionally diluted with water to extract analytes of interest for analysis. The DBS sample and solvent can be shaken, vortexed, and/or subjected to sonication such as ultrasonic energy to improve the efficiency of the extraction process. The mixture can be centrifuged prior to transfer to a vial or container 18, where an aliquot can be injected or otherwise loaded into an analyzer 20 such as an analytical measurement system such as a high performance liquid chromatography (HPLC) system, an ultra-performance liquid chromatography (UPLC) system, and/or a mass spectrometer.

Conventional techniques, for example, as shown in FIG. 1, require several time-consuming, error-prone steps that require the transfer of the sample to different devices; namely: the spotting, drying, and punching of the blood sample at a collection card, the transfer of the punched sample to an extraction tube, the addition of extraction solvent, the mixing and centrifuging of the mixture at the extraction tube, the transfer of an aliquot of the extract to another vial, and the injection of the aliquot to an analyzer.

A common approach for tracking the sample is to manually label each container in the workflow process. In doing so, the collection card 10, extraction tube 16, and container 18 can each include a sample identification 15, 17, 19, respectively, such as a label, barcode, a handwritten note, or other identification, for identifying the sample at these steps of the sample workflow process. In other words, multiple identifications, each on a different container, can include information referring to the same sample. However, this approach is prone to error and may result in misidentification or loss of the sample. For example, the sample may be prone to misplacement during a transfer between the card 10, the extraction tube 16, and the container 18, respectively. In another example, the risk of intentional tampering is available, for example, a purposeful misidentification of samples.

In accordance with embodiments of the present inventive concepts, apparatuses and methods are provided that permit a user such as an analyst to track a sample throughout a workflow process, which may include tasks such as dissolving, extracting, transferring, filtering, and/or analyzing the sample. An identification is associated with the sample at the time of collection and remains with the sample throughout the process. Accordingly, an analyst or other user is not required to label different containers for manually tracking a sample for performing such tasks, thereby reducing the risk of misidentification or other tracking-related error of samples during the workflow process.

An apparatus in accordance with some embodiments can be used as a sampling device or the like for various applications, such as food analysis or environmental sample analysis. As described herein, embodiments of an apparatus can include but not be limited to various containment structures constructed to include a sample identifier such as a barcode, tag, or the like, in order to maintain the identification of a sample from the time of collection of the sample at the apparatus throughout a workflow process, for example, during analysis of the sample. Accordingly, potential issues associated with conventional techniques, in particular, unintentional sample misidentification and intentional tampering, are eliminated by the present inventive concepts.

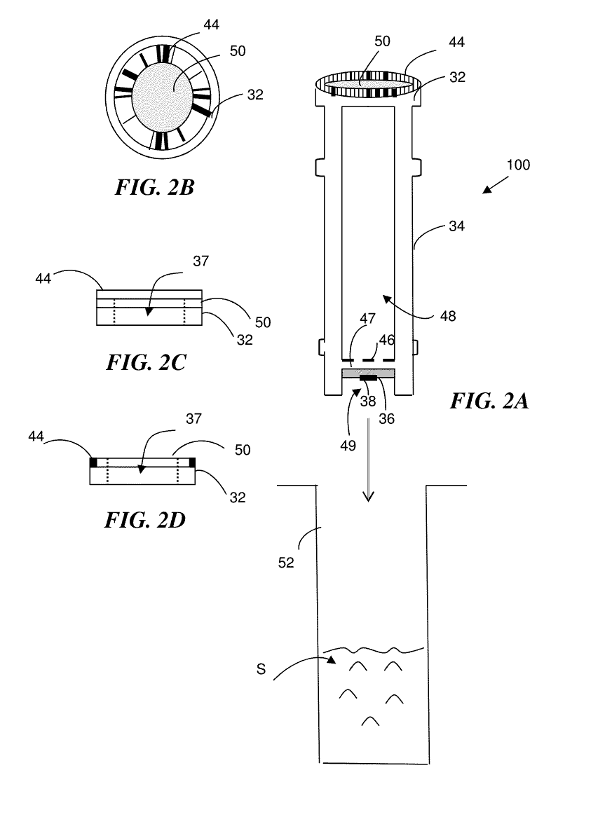

FIG. 2A is a cross-sectional view of a collection and processing device 100 with container 52, in accordance with some embodiments. FIG. 2B is a top view of the collection and processing device 100 of FIG. 2A. FIG. 2C is a detailed view of the collection and processing device 100 of FIG. 2A and FIG. 2B. FIG. 2D is a detailed view of the collection and processing device 100 of FIGS. 2A-2B, in accordance with another embodiment.

The collection and processing device 100 can include a body 34. The body 34 preferably includes but is not limited to a tubular, tapered, or cylindrical configuration, or related container configuration known to those of ordinary skill in the art. For example, the body 34 can be tapered at the open end 49 of the chamber 48. In some embodiments, the body 34 is the same as or similar to one or more apparatuses described in International application no. PCT/US13/61512, filed Sep. 25, 2013, incorporated by reference herein. The body 34 can be formed of materials known to those of ordinary skill in the art, for example, plastics or related molded composites.

The body 34 can include a partition 47 that divides the chamber 48 into two adjacent compartments. The first compartment has the partition 47 facing opposite an open end 49 of the chamber 48. The second compartment has the partition 47 facing opposite an end of the chamber covered by a septum 50 or related thin penetrable barrier. The partition 47 includes one or more openings or channels 46 that can extend between the absorbent medium 36 and a reservoir or chamber 48 of the body 34 and allow passage of fluid from the first compartment into the second compartment. In some embodiments, a filtration medium is disposed in the first compartment between the absorbent medium 36 and the partition 47 to filter liquid. In some embodiments, a cleanup medium is disposed in the first compartment, for example, adjacent the partition 47 or between the absorbent medium 36 and the filter medium, to remove constituents from the liquid.

When the collection and processing device 100 is pressed into a container, for example, container 52 shown in FIG. 2A, extraction fluid (S) can be forced through the absorbent medium 36 at a distal end of the body 34 via the openings or channels 46 into the second compartment of the chamber 48 of the body 34. The absorbent medium 36 can be a portion of a commercially available biological matrix paper such as a Guthrie card or related dried biological sample spot card.

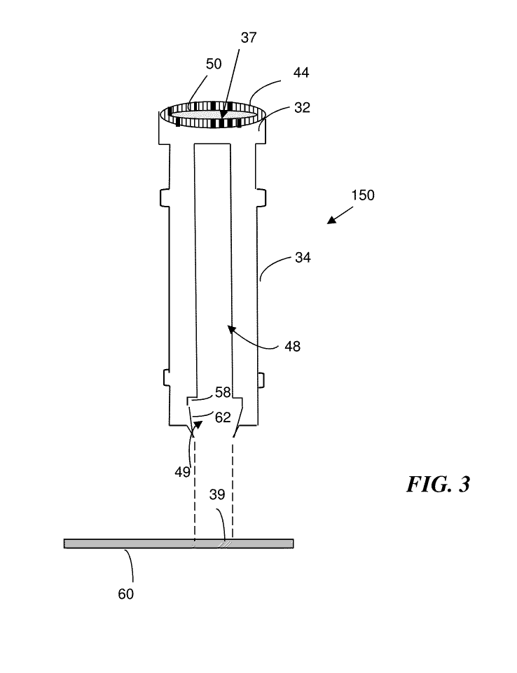

An inner wall of the body 34 can include a groove, lip, mount, support, or other restraining device for holding the absorbent medium 36 in place. A fluid sample 38 or the like capable of absorption can be directly applied to the absorbent medium 36 positioned in the body 34. Alternatively, a sample can be applied to the absorbent medium 36 separate from the device 100, and subsequently the absorbent medium 36 and the sample 38 can be inserted in the body 34, for example, described below with respect to FIG. 3. In other embodiments, a solid sample can be positioned in the body 34, for example, obviating the need of an absorbent media. In the devices 100, 150 of FIGS. 2A-2D and FIG. 3, respectively, the collected sample is not separated from a tracking identification 44 during subsequent sample handling processes.

The collection and processing device 100 can be constructed and arranged to perform multiple functions, similar to one or more apparatuses described in International application no. PCT/US13/61512, filed Sep. 25, 2013, incorporated by reference herein. For example, at the device 100, the sample can be extracted from the absorbent medium 36 for analysis and output to the chamber 48 via the openings or channels 46.

The tracking identification 44 is collocated with a septum 50 positioned about the opening 37 at the top region 32 of the body 34. In some embodiments, as shown in FIG. 2C, the tracking identification 44 is permanently affixed to a face of the septum 50, which in turn is coupled to, integrated with, or otherwise in communication with a periphery of the top region 32. In other embodiments, as shown in FIG. 2D, the tracking identification 44 is permanently affixed to an external surface around the body 34, for example, to at least partially surround the septum 50. Here, the tracking identification 44 and the septum 50 are each directly coupled to a surface of the top region 32. In an embodiment, the tracking identification 44 is integral with the top region 32, for example, etched, hardcoded, or preprinted into the top region 32. In an embodiment, the identification 44 is integral with the septum 50, for example, etched into the septum 50. In some embodiments, the tracking identification 44 can be constructed and arranged in relationship to the septum 50 so that the tracking identification 44 along with the septum is pierced during an injection process. In doing so, the tracking identification 44 can be destroyed, which can be beneficial in certain applications, for example, applications where the sample is to be accessed only once. In other embodiments, the tracking identification 44 is at a side surface of the top region 32.

The tracking identification 44 can include a barcode, a radio frequency (RF) tag, a magnetic strip, and/or identifier that is processed by a machine. The barcode can be a two-dimensional (2D) barcode, an iris barcode, or other barcode known to those of ordinary skill in the art. Data corresponding to the sample at the collection and processing device 100 can be encoded or otherwise stored at the tracking identification 44. Representative data can include but not be limited to a name, identification number, address, blood type, or other data relevant to the processing of the sample during a workflow process.

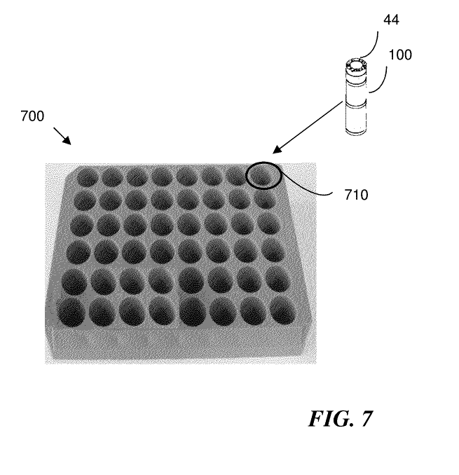

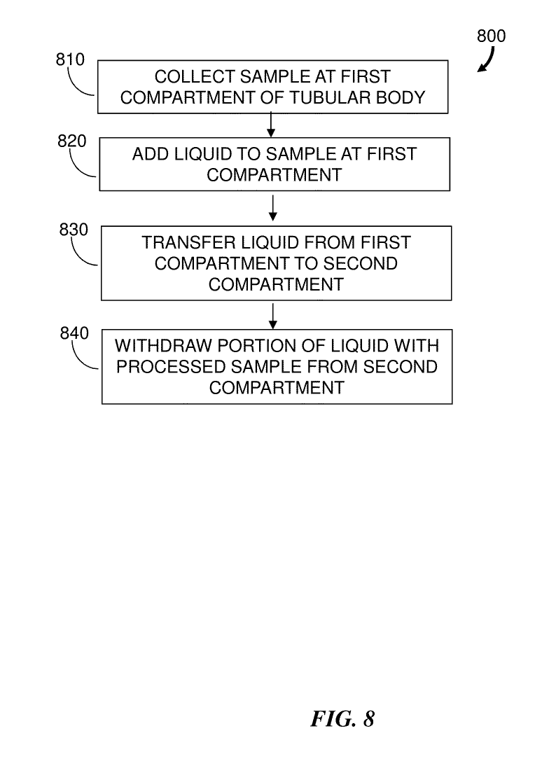

The tracking identification 44 constructed and arranged at a top region 32 of each body 34 of a plurality of collection and processing devices 100 allows for a particular tracking identification 44 to be read for identifying a corresponding sample among the co-located samples, for example, when a plurality collection and processing devices 100, each spotted with a sample, are co-located in a tray or related platform as shown in FIG. 7.

In an embodiment, the top region 32 includes an opening 37 for accessing the chamber 48. The top region 32 is preferably formed of a same mold or machined from a common stock as the rest of the body 34. In other embodiments, the top region 32 can be formed separately from the body 34 and is glued, bonded, or otherwise permanently coupled to an end of the body 34. In some embodiments, the top region 32 can be constructed and arranged as a cap that is removably coupled to the body 34. In such embodiments, the tracking identification 44 on a removable cap or the like can address problems related to unintentional misidentification. In other embodiments where the top region 32 and the body 34 are integral, formed of the same material, or otherwise permanently coupled to each other, problems related to unintentional misidentification of samples can be overcome. In these embodiments, since the top region 32 cannot be separated from the body 34 after sample collection, problems related to intentional sample tampering can also be overcome.

The septum 50 can be a pierceable and/or pre-slit thin penetrable barrier that covers the opening 37 and closes the chamber 48 at a one end, or first end, of the container body 34. The chamber 48 is open at the other end, or a second end, of the container body 34, for example, proximal a region where the medium 36 is positioned. The septum 50 can be pierced with a pipette, syringe needle, or other related sharp object, which can be inserted through the septum 50 to the chamber 48 for removing an aliquot from the chamber 48 of the body 34, and/or providing an external fluid, gas, and/or solid to the chamber.

The device body 34 can be inserted into a container 52 that holds an extraction solvent S or other liquid. Although a container 52 is shown, a cup, well, or related receiving apparatus can equally apply. In doing so, when the body 34 is pressed into the container 52, the extraction liquid S can be forced through the medium 36 and the openings 46 into the chamber 48 of the body 34. Injection into an HPLC system can be made directly from the combined assembly of the device 100 at least partially positioned in a cup, well, or the like.

FIG. 3 shows a cross-sectional view of a collection and processing device 150, in accordance with another embodiment. The collection and processing device 150 can be similar or the same as the collection and processing device 100 described with respect to FIGS. 2A-2D, with at least one noticeable difference. The body 34 of the collection and processing device 150 of FIG. 3 can be constructed and arranged as a hollow tube or the like. A cutter 62 extends from an edge of the body 34 at the open end of the chamber 48. An inner wall of the body 34 can include a groove, lip, mount, support, or other restraining device 58 proximal the cutter 62 for receiving a sample 39 and holding it in place. The sample 39 is a detached portion from a larger sample, 60. Sample 60 can be a tissue sample, food sample, or other solid sample. Alternatively, sample 60 can be an absorbent media that includes an absorbed fluid, and sample 39 could include a portion of, or the entire absorbed fluid. The absorbent media can be part of a conventional media, for example, the DBS card 10 shown in FIG. 1. A force can be applied to the device 150, for example, at the top region 32 of the device 150, which is sufficient for the cutter 62 to cut through a perimeter of the selected region (shown by dashed lines), and thereby collect the sample 39. The region having the selected sample 39 can be inserted in the body 34, and positioned at the groove, lip, mount, support, or other restraining device 58. Once inserted in the collection and processing device 150, the collected sample 39 is not separated from the tracking identification 44 during subsequent sample handling processes.

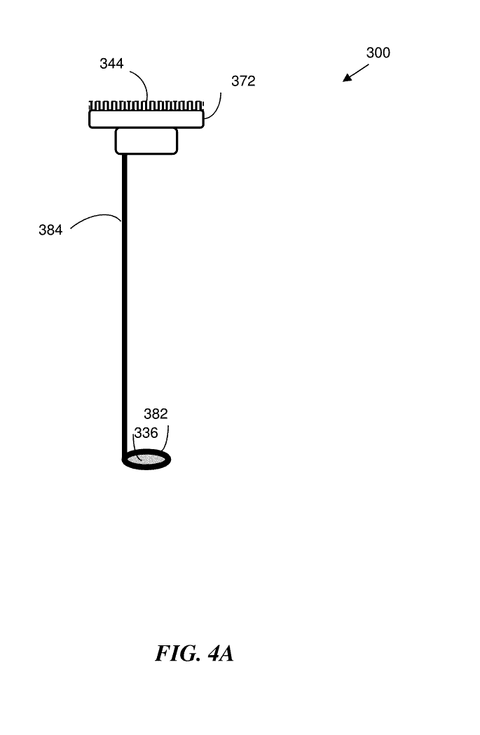

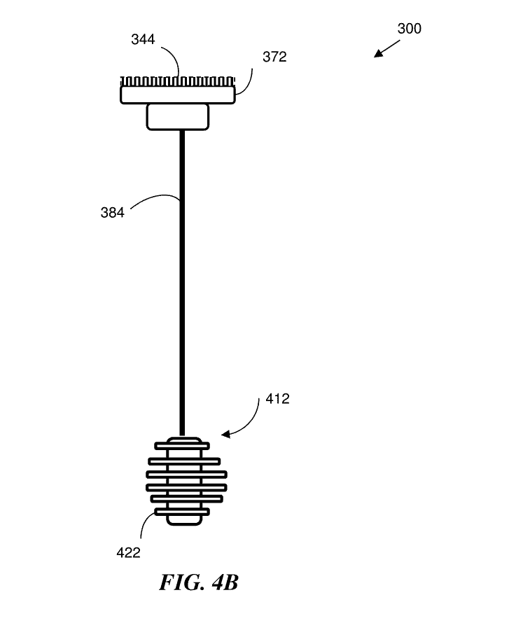

FIG. 4A is a view of a collection and processing device 300, in accordance with another embodiment. FIG. 4B is a view of the collection and processing device 300 of FIG. 4A, in accordance with another embodiment.

In one embodiment, for example, shown in FIG. 4A, a distal end of the device 300 includes a support ring 382 at which a sample 336 can be positioned. The sample 336 can be similar or the same as a sample described herein, for example, a liquid sample and/or a solid sample. The support ring 382 can optionally hold an absorbent material or the like on which the sample is located. The support ring 382 can be positioned in a vial, tube, or the like, for example, to store the sample, or where a solvent can be added, whereby the sample 336 can be diluted, dissolved, mixed, extracted, or otherwise processed. The support ring 382 can alternatively be a sample-holding element that has a different shape than a ring shape to hold the sample 336, for example, a disk, square, rectangular, elliptical, or parabolic shape.

In another embodiment, as shown in FIG. 4B, the distal end of the device 300 includes a honey-dipper member 412. The honey-dipper member 412 can include a set of annular ribs 422, or plates or other protrusions extending from the support device 484, each constructed and arranged to collect a liquid sample. The honey-dipper member 412 can be positioned in a vial, tube, or the like, for example, whereby the sample can be diluted, dissolved, mixed, extracted, stored, and/or otherwise processed. Although a support ring and a honey-dipper member are described herein, embodiments are not limited therewith. Accordingly, any sample collection element known to those of ordinary skill in the art can equally apply.

A proximal end of the collection and processing device 300 can include a cap 372. The cap 372 can provide a seal-tight interface with a vial, tube, or the like. The cap 372 can include a septum.

A support device 384 can be attached between the support ring 382 (FIG. 4A) or honey-dipper member 412 (FIG. 4B) and the cap 372. The support device 384 or body, also referred to as a dipstick, can be long and rigid, for example, rod-shaped, and can be formed of metals, plastics, composites, or other materials known to those of ordinary skill in the art. Alternatively, the support device 384 can be flexible or otherwise lack rigidity, for example, a string, which has sufficient strength permitting a user to remove the support ring 382, honey-dipper member 412, or related sample capturing element from a vial, tube, or the like, and/or insert the support ring 382, honey-dipper member 412, or related sample capturing element into the vial, tube, or the like.

A tracking identification 344 is positioned on a surface of the cap 372. In other embodiments, in lieu of a cap 372, a base or other element can be positioned at the second end of the support device 384, having a top region on which the tracking identification 344 can be provided. The tracking identification 344 can include a barcode, a radio frequency (RF) tag, a magnetic strip, and/or identification that is processed by a machine. The barcode can be a two-dimensional (2D) barcode.

Since the tracking identification 344 is integrated with or otherwise coupled to the cap 372, a sample collected at the support ring 382, honey-dipper member 412, or other sample collection element is not separated from the tracking identification 344 during subsequent sample handling processes.

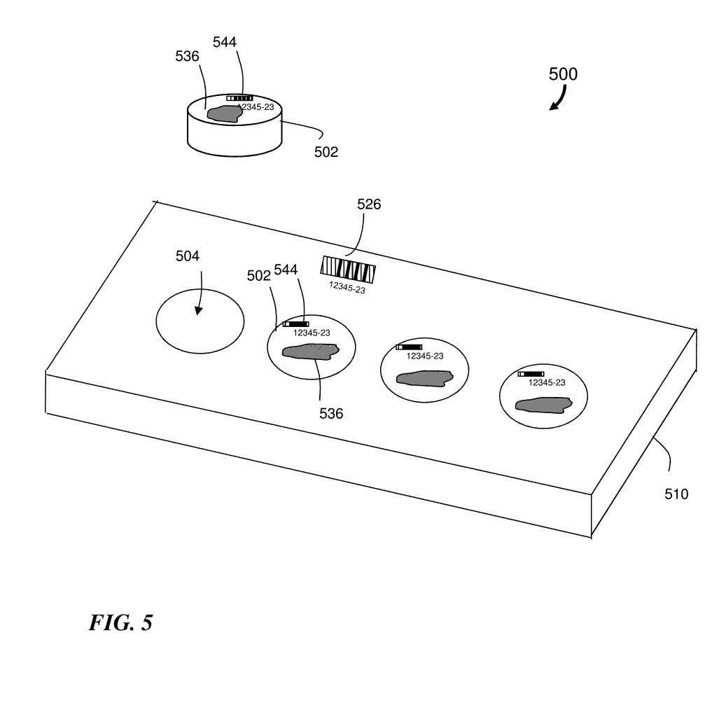

FIG. 5 is a perspective view of a planar collection and processing device 500, in accordance with another embodiment.

The planar device 500 can be constructed and arranged to include a plurality of removable sample rings 502 at a support structure 510 of the device 500. The sample rings 502 can be positioned in a support structure 510 according to a predetermined arrangement, for example, a linear arrangement, a 2x2 arrangement, and so on. Each sample ring 502 can include a sample region 536 on which a tracking identification 544 can be located. The sample region 536 can be formed of a material similar or the same as that of an absorption medium described in embodiments herein, permitting a fluid sample to be at the absorption medium at the sample ring 502. Alternatively, the sample region 536 can have a surface that permits a solid sample to be positioned thereon, for example, for a matrix-assisted laser desorption/ionization (MALDI) technique or the like.

Any of the sample rings 502 can be removed from the support structure 510 for extraction, analysis, or other purposes. One or more sample rings 502, along with their tracking identifications 544, can be punched or otherwise removed from the support structure 510, for example, where each sample ring 502 is attached to the support structure 510 by a perforation perimeter or the like. Alternatively, the sample rings 502 can be positioned in holes 504 in, and removed from, the support structure 510. A removed sample ring 502 can be transferred to another apparatus such as a tube, vial, etc., for extraction, storage, analysis by a chromatography system, or other related process step. Since the tracking identification 544 is integral with the sample ring 502, a sample at the sample ring 502 is not separated from the tracking identification 544 during subsequent sample handling processes.

The support structure 510 can also include a tracking identification 526 such as a label that can include information related to the planar device 500 including its samples. The tracking identifications 544 and/or 526 can include a barcode, a radio frequency (RF) tag, a magnetic strip, and/or identification that is processed by a machine. The tracking identification 526 can include some or all data provided at the tracking identifications 544 of the sample rings 502, and/or can include different data.

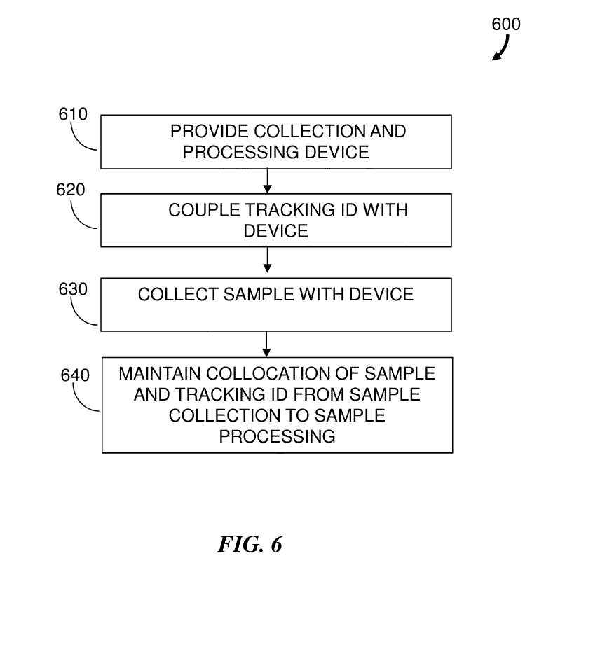

FIG. 6 is a flowchart illustrating a method 600 for tracking a sample, in accordance with an embodiment. In describing the method 600, reference can be made, but not limited, to elements of illustrative embodiments described herein, for example, elements of FIG. 2-5.

At block 610, a collection and processing device is provided, for example, a device illustrated and described herein.

At block 620, a tracking identification is coupled to the collection and processing device, so that the tracking identification is collocated with the device throughout a workflow process. In particular, the tracking identification can be positioned at a region of the collection and processing device, or integrated with the collection and processing device, for example, etched, hardcoded, or preprinted into a surface of the device.

At block 630, the collection and processing device can receive and collect a sample, for example, described herein. In some embodiments, the sample is collected at an absorbent media at the collection and processing device. In other embodiments, for example, shown in FIG. 3, the sample is collected at the absorbent media first, then provided with the absorbent media to the collection and processing device. In some embodiments, the sample is collected by the device with no absorbent media, for example, a solid sample. Accordingly, the tracking identification at the device can be directly associated with the sample, for example, to uniquely identify the sample to distinguish the sample from other samples.

At block 640, the sample is collocated with its corresponding tracking identification during a sample handling process, for example, during preparation and analysis of the sample. Accordingly, the tracking identification is never disassociated from that sample during a workflow process. The tracking identification can be read, scanned, or otherwise processed at any step of the sample handling process.

FIG. 7 is a view of a collection and processing device 100 constructed and arranged for positioning in a well plate 700, in accordance with an embodiment. The well plate 700, or tray or related apparatus, can include an array, i.e., rows and columns, of wells 710, each capable of receiving a collection and processing device 100, 150, 300, or 502 in accordance with embodiments of present inventive concepts. The well plate 700 can alternatively include a plurality of containers or the like, for example, described with reference to FIG. 2A, positioned in the well plate 700, each capable of receiving a collection and processing device 100, 150, 300, or 502 in accordance with embodiments of the present inventive concepts.

The collection and processing device 100, 150, 300, or 502 can be inserted in a well plate 700, or a container in the well plate 700, so that the tracking identification 44 is displayed while positioned in a well 710. Accordingly, a plurality of collection and processing devices can be grouped together.

FIG. 8 is a flowchart illustrating a method 800 for sample collection and processing for use in a laboratory workflow process, in accordance with an embodiment. In describing the method 800, reference can be made, but not limited, to elements of illustrative embodiments described herein.

At block 810, a sample 38 is collected at a first compartment of a tubular body. For example, as shown in FIG. 2A, a tubular body 34 includes a first compartment at a chamber 48 and a second compartment at an opening 49 separated from each other by a partition 47.

At block 820, liquid such as an extraction solvent is added to the sample 38 at the absorbent media 36 in the first compartment at the opening 49 of the tubular body 34 to process the sample 38. Adding liquid in this manner operates to process the sample by extraction, dissolution, and/or dilution.

At block 830, liquid is transferred from the first compartment to the second compartment of the tubular body 34 through one or more holes in the partition 47. For example, referring again to FIG. 2A, the device body 34 can be inserted into a container 52 that holds an extraction solvent S or other liquid. When the body 34 is pressed into the container 52, the extraction liquid S can be forced through the absorbent medium 36 at the partition 47 and the openings 46 into the second compartment of the chamber 48 of the body 34.

At block 840, a portion of the liquid with the processed sample is withdrawn from the second compartment through a penetrable thin barrier such as a septum 50 forming a closed end of the tubular body 34 opposite the open end 49.

A tracking identification 44 can be permanently affixed to a surface of the closed end of the tubular body 34. Accordingly, in a laboratory workflow process, the sample collection and processing device 100 can be transferred from a first station where the sample 38 is collected into the first compartment, to one or more intermediate stations where liquid S is added to the first compartment and transferred to the second compartment of the tubular body 34, then to a final station where the portion of the liquid S with the processed sample 38 is withdrawn via the septum 50 from the second compartment of the chamber 48 for analysis.

A number of implementations have been described. Nevertheless, it will be understood that additional modifications may be made without departing from the scope of the inventive concepts described herein, and, accordingly, other embodiments are within the scope of the following claims.

What is claimed is:

1. A sample collection and processing device comprising:
a tubular body having a chamber closed at a first end by a thin penetrable barrier and open at a second end opposite the first end, the tubular body further including a partition that divides the chamber into two adjacent compartments, wherein a first compartment of the two adjacent compartments has the partition facing opposite the open end of the chamber and a second compartment of the two adjacent compartments has the partition facing opposite the closed end of the chamber, the partition having one or more holes to allow passage of fluid from the first compartment into the second compartment.

2. The device of claim 1, further comprising an absorbent medium, used to collect a sample, disposed in the first compartment adjacent to the partition.

3. The device of claim 2, further comprising a filtration medium, used to filter liquid, disposed in the first compartment between the absorbent medium and the partition.

4. The device of claim 3, further comprising a cleanup medium, used to remove constituents from liquid, disposed in the first compartment between the absorbent medium and the filter medium.

5. The device of claim 2, wherein the absorbent medium is a portion of a dried biological sample spot card.

6. The device of claim 1, further comprising a filtration medium, used to filter liquid, disposed in the first compartment adjacent to the partition.

7. The device of claim 1, further comprising a cleanup medium, used to remove constituents from liquid, disposed in the first compartment adjacent to the partition.

8. The device of claim 1, wherein the partition comprises an absorbent medium used to collect a sample.

9. The device of claim 8, wherein the absorbent medium is a portion of a dried biological sample spot card.

10. The device of claim 1, further comprising a cutter extending from an edge of the tubular body at the open end of the chamber.

11. The device of claim 1, further comprising a tracking identification permanently affixed to a face of the thin penetrable barrier that closes the first end of the chamber.

12. The device of claim 1, further comprising a tracking identification permanently affixed to an external surface around the tubular body at the closed end of the chamber.

13. The device of claim 1, wherein the thin penetrable barrier comprises a septum.

14. The device of claim 1, wherein the tubular body is tapered at the open end of the chamber.

15. The device of claim 1, further comprising a container for holding a liquid, the container having an open end sized for closely receiving the open end of tubular body.

16. A method for sample collection and processing for use in a laboratory workflow process, the method comprising:
collecting a sample into a first compartment of a tubular body of a sample-collection and processing device through an open end of the tubular body;
adding liquid to the sample in the first compartment of the tubular body to process the sample;
transferring liquid from the first compartment of the tubular body into a second compartment of the tubular body through one or more holes in a partition disposed between the compartments; and
withdrawing a portion of the liquid with the processed sample from the second compartment through a penetrable thin barrier forming a closed end of the tubular body opposite the open end.

17. The method of claim 16, wherein collecting a sample into a first compartment of a tubular body through an open end of the tubular body includes collecting the sample with an absorbent medium disposed in the first compartment adjacent to the partition.

18. The method of claim 16, wherein collecting a sample into a first compartment of a tubular body through an open end of the tubular body includes cutting an absorbent medium from a dried biological sample spot card with the sample and inserting the absorbent medium with the sample into the first compartment of the tubular body.

19. The method of claim 16, wherein the partition comprises an absorbent medium.

20. The method of claim 16, further comprising permanently affixing tracking identification to a surface at the closed end of the tubular body.

21. The method of claim 20, further comprising transporting the sample collection and processing device from a first station in the laboratory workflow process where the sample is collected into the first compartment, to one or more intermediate stations where liquid is added to the first compartment and is transferred to the second compartment, and then to a final station in the laboratory workflow process, where the portion of the liquid with the processed sample is withdrawn from the second compartment for analysis.

22. The method of claim 16, wherein the thin penetrable barrier comprises a septum.

23. The method of claim 16, wherein adding liquid to the sample in the first compartment of the tubular body includes inserting the open end of the tubular body into a container holding the liquid.

24. The method of claim 23, wherein the inserting of the open end of the tubular body into the container holding the liquid forces the liquid with the processed sample from the first compartment of the tubular body into the second compartment of the tubular body through the one or more holes in the partition disposed between the compartments.

25. The method of claim 16, wherein adding liquid to the sample in the first compartment of the tubular body operates to process the sample by at least one of extraction, dissolution, and dilution.
